(19) United States
(12) Patent Application Publication
(10) Pub. No.: US 2026/0029352 A1
(43) Pub. Date: Jan. 29, 2026

(54) INTERNAL INSPECTION DEVICE FOR PRISMATIC CAN OF SECONDARY BATTERY

(71) Applicant: ENSCAPE CO., LTD., Yongin-si (KR)

(72) Inventors: Ji Man RYU, Suwon-si (KR); Dong Hyun JUNG, Hwaseong-si (KR); Seong Gi KIM, Asan-si (KR); In Ho KA, Seongnam-si (KR); Sang Jin CHOI, Seongnam-si (KR)

(21) Appl. No.: 19/232,004

(22) Filed: Jun. 9, 2025

(30) Foreign Application Priority Data
Jul. 29, 2024 (KR) 10-2024-0100151
Nov. 5, 2024 (KR) 10-2024-0155193

(51) Int. Cl. G01N 21/90

(52) U.S. Cl. CPC G01N 21/90

(57) ABSTRACT

The present disclosure relates to an internal inspection device for a prismatic can of a secondary battery capable of detecting defects inside the prismatic can of the secondary battery through reflected images obtained by adjusting the positions and angles of mirrors. The internal inspection device for a prismatic can of a secondary battery according to the present disclosure is capable of visual inspection of the interior without involving a posture change of the prismatic can, thereby improving the speed and accuracy of inspection.

### CROSS-REFERENCE TO RELATED APPLICATIONS

This application claims the benefit of Korean Patent Application Nos. 10-2024-0100151, filed on Jul. 29, 2024, and 10-2024-0155193, filed on Nov. 5, 2024, the contents of which are all hereby incorporated by reference herein in their entirety.

### BACKGROUND

### Field

The present disclosure relates to an internal inspection device for a prismatic can of a secondary battery and, more particularly, to an internal inspection device capable of capturing accurate internal images without changing the posture of the target object.

This application is one of the results of the small and medium sized company's technology innovation development program (R&D) (Development of AI vision inspection system for square battery's CAN·CAP components, project identification number: 00277033) under the supervision of the Korea Technology and Information Promotion Agency for SMEs (TIPA).

### Description of Related Art

In the process of producing secondary batteries, various inspection methods are used to determine whether the can forming the outer casing is free of defects or defective. Among the methods, a vision inspection device is used to capture images of the object and identify any defects in its appearance. Since a minor defect in the can of a secondary battery may become a serious flaw in the final product, defect inspection of the can has to be conducted with higher precision and accuracy.

Korean Patent No. 1287464 discloses an inspection device for secondary battery cans. However, the prior art reveals a problem in capturing clear images of the interior of the can and identifying defects from the images.

### PRIOR ART REFERENCES

### Patent Document

Korean Patent No. 1287464

### SUMMARY

An object of the present disclosure is to provide a device capable of improving efficiency and accuracy of internal inspection for prismatic cans of secondary batteries in the prior art.

To achieve the object of the present disclosure, an internal inspection device for a prismatic can of a secondary battery may be provided, the device comprising a mounting unit configured to mount a prismatic can for a secondary battery; a large surface imaging module configured to capture images of an inner large surface of the prismatic can mounted on the mounting unit; and a small surface imaging module configured to capture images of an inner small surface of the prismatic can mounted on the mounting unit, wherein the large surface imaging module comprises a first camera, a first coaxial lighting unit, a first mirror, and a first mirror adjustment unit; the small surface imaging module comprises a second camera, a second coaxial lighting unit, a second mirror, and a second mirror adjustment unit; the first mirror adjustment unit is configured to adjust the position and/or angle of the first mirror; and the second mirror adjustment unit is configured to adjust the position and/or angle of the second mirror.

Meanwhile, the first mirror and the first mirror adjustment unit may be provided in pairs to capture images of a pair of large surfaces.

Also, the small surface imaging module may be configured to capture images of a small surface viewed from different angles according to the height of the small surface.

Meanwhile, the small surface imaging module may be configured as a pair.

Meanwhile, the pair of first mirrors may be provided on the outer sides of the pair of large surfaces, each configured to incline at a predetermined angle in the upward direction.

Also, the device may further include a fixed frame configured to hold the large surface imaging module and the small surface imaging module above a predetermined height, and the mounting unit may be configured to move inwardly within the fixed frame.

Meanwhile, the first camera may be configured to adjust the focus in response to the angle and/or position adjustment of the first mirror.

Furthermore, the second camera may be configured to adjust the focus in response to the angle and/or position adjustment of the second mirror.

Meanwhile, the first coaxial lighting unit may be configured to include a plurality of first lighting units, and the plurality of first lighting units may be configured to be individually controlled.

Meanwhile, the second coaxial lighting unit may be configured to include a plurality of second lighting units, and the plurality of second lighting units may be configured to be individually controlled.

The internal inspection device for prismatic cans of secondary batteries according to the present disclosure is capable of capturing internal images without involving a posture change of the can, thereby improving the speed and accuracy of inspection.

### BRIEF DESCRIPTION OF THE DRAWING

FIG. 1 shows a prismatic can according to the present disclosure, which is an inspection target.

FIG. 2 is a perspective view of an internal inspection device for the prismatic can of a secondary battery according to one embodiment of the present disclosure.

FIG. 3 is an exploded perspective view of an internal inspection device for the prismatic can of a secondary battery.

FIG. 4 is a perspective view of a first mirror and a first mirror adjustment unit.

FIG. 5 is an exploded perspective view of the first mirror adjustment unit.

FIG. 6 shows an operation state illustrating the angle adjustment operation of the first mirror adjustment unit.

FIG. 7 illustrates the operation of a large surface imaging module according to one embodiment of the present disclosure.

FIG. 8 illustrates the operation of a small surface imaging module according to one embodiment of the present disclosure.

FIG. 9a illustrates the imaging area according to the operation of the large surface imaging module according to one embodiment of the present disclosure.

FIG. 9b illustrates the imaging area according to the operation of the small surface imaging module according to one embodiment of the present disclosure.

FIGS. 10a and 10b are images obtained by the operation of the large surface imaging module according to one embodiment of the present disclosure.

FIGS. 11a and 11b are images obtained by the operation of the small surface imaging module according to one embodiment of the present disclosure.

### DETAILED DESCRIPTION

In what follows, an internal inspection device for a prismatic can of a secondary battery according to an embodiment of the present disclosure will be described in detail with reference to accompanying drawings. In the description of the following embodiments, the name of each constituting element may be referred to differently in the art to which the present disclosure belongs. However, if the constituting elements have functional similarity and identity, they may be regarded as forming an equivalent configuration even if a modified embodiment is employed. Meanwhile, symbols assigned to the individual constituting elements have been introduced for the convenience of description. However, it should be noted that the content illustrated by the drawings containing the symbols is not limited to the immediate scope depicted by the drawings. Likewise, even if an embodiment that partially modifies the configuration in the drawings is employed, the embodiment may be regarded as an equivalent configuration if functional similarity and identity exist. In addition, if a constituting element is regarded by those skilled in the art to which the present disclosure belongs as a basic part that should be included, the description thereof will be omitted.

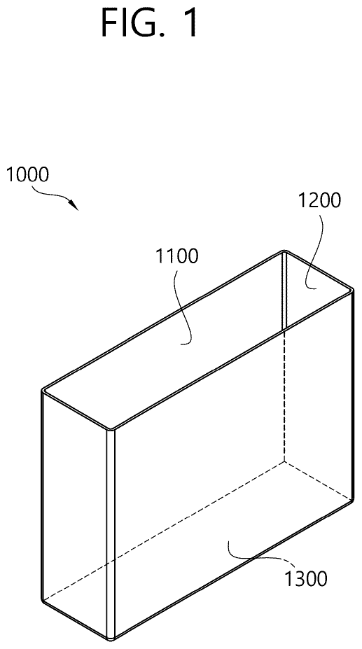

FIG. 1 shows a prismatic can 1000 according to the present disclosure, which is an inspection target.

Referring to FIG. 1, the prismatic can 1000, which is the inspection target of the present disclosure, may be applied in the manufacturing process of batteries, such as secondary batteries. The inner surface of the prismatic can 1000 is composed of five surfaces. Four of them are side surfaces, in which two side surfaces have wider widths and the other two side surfaces have narrower widths. One surface is defined as a bottom surface 1300. One side of the prismatic can 1000 remains in an open state during inspection.

In what follows, the side surface with a wider width (longer side) among the side surfaces is referred to as a ‘large surface 1100,’ and the side surface with a narrower width (shorter side) is referred to as a ‘small surface 1200.’

In the present disclosure, the prismatic can 1000 for a secondary battery has a large surface 1100, a small surface 1200, and a bottom surface 1300, all formed in a planar shape and connected to each other at right angles. At this time, a curved edge is formed at each connecting portion.

The internal inspection device 1 for the prismatic can of a secondary battery according to the present disclosure is configured to perform a vision inspection on the large inner surface 1100, the small inner surface 1200, and the bottom surface to accurately detect defects.

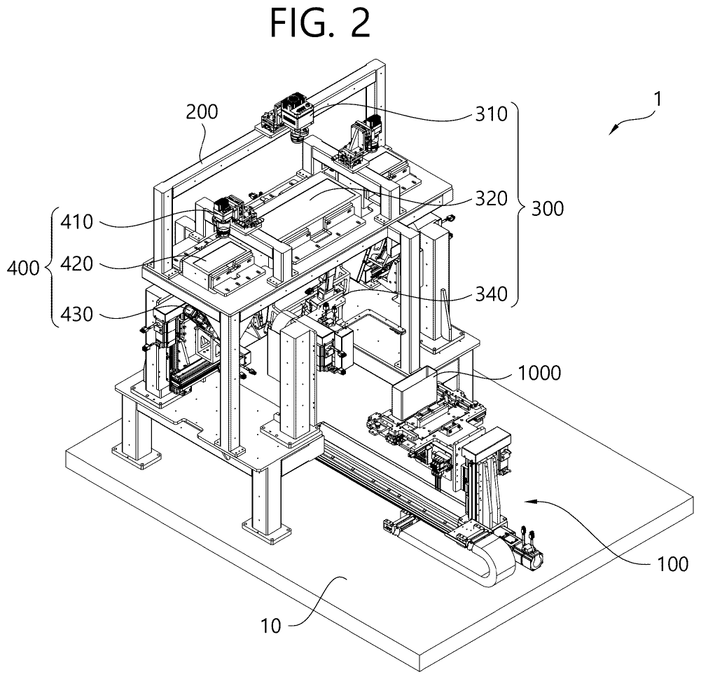

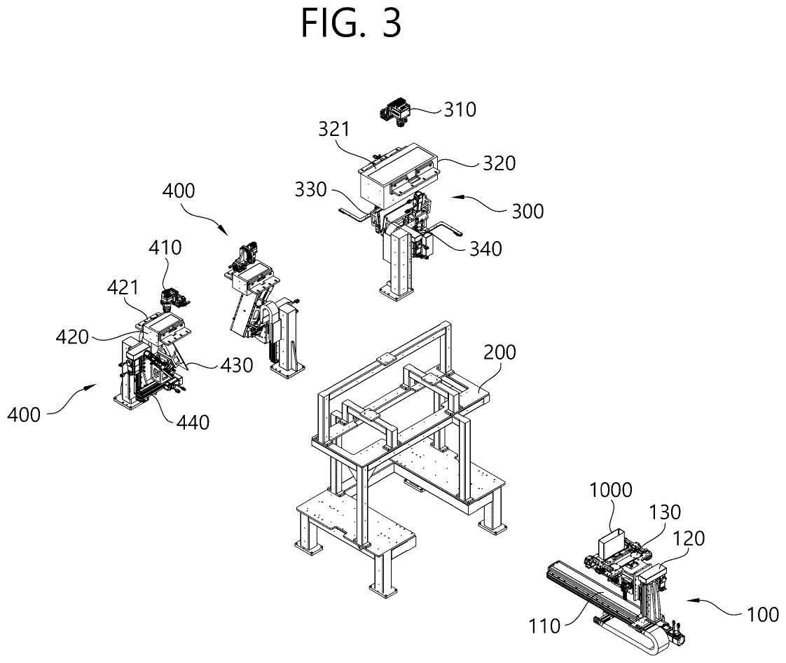

FIG. 2 is a perspective view of an internal inspection device for the prismatic can of a secondary battery according to one embodiment of the present disclosure, and FIG. 3 is an exploded perspective view of an internal inspection device for the prismatic can of a secondary battery.

Referring to FIGS. 2 and 3, the internal inspection device 1 for the prismatic can 1000 according to one embodiment of the present disclosure is configured to distinguish between the large surface 1100 and the small surface 1200 of the prismatic can 1000 and to actively adjust the mirror angle to obtain an accurate internal image.

The internal inspection device 1 for the prismatic can 1000 according to one embodiment of the present disclosure may be configured to include a base 10, a fixed frame 200, a mounting unit 100, a large surface imaging module 300, and a small surface imaging module 400.

The base 10 extends horizontally, which serves as a supporting structure on which other constituting elements of the present disclosure may be provided.

The fixed frame 200 is configured to hold the large surface imaging module 300 and the small surface imaging module 400. The fixed frame 200 is secured to the large surface imaging module 300 and the small surface imaging module 400 above a predetermined height. The fixed frame 200 may be configured to have several layers. Depending on the height, the fixed frame may be configured to have a mirror, which will be described later, or a camera. However, the frames illustrated in FIGS. 2 and 3 are only examples and may be applied in various shapes in which a camera and/or a mirror may be provided.

The mounting unit 100 is configured to hold a secondary battery can. The mounting unit 100 is configured so that an open secondary battery can is mounted facing the camera. For example, the mounting unit 100 may be configured to hold at least one secondary battery can at predetermined intervals. Also, the mounting unit 100 may be configured to move horizontally on the base by the mounting unit adjustment unit.

The mounting unit adjustment unit may include a mounting unit horizontal driving unit 110, a mounting unit vertical driving unit 120, and a clamp 130. The mounting unit horizontal driving unit 110 and the mounting unit vertical driving unit 120 are configured to adjust the horizontal or vertical position of the mounting unit 100 and may be composed of linear movement elements, for example, a linear motor.

The clamp 130 is configured to hold the mounted prismatic can 1000 and may be selectively operated by the controller. The clamp 130 may selectively hold the can 1000 from the outside of the prismatic can 1000.

When the mounting unit adjustment unit operates, it may avoid interference with mirrors to be described later and move the secondary battery can to an inspection position. The inspection position may be a space defined by the fixed frame 200, which may be, for example, the lower side of the fixed frame 200.

The large surface imaging module 300 is configured to capture images of a pair of large surfaces 1100 and the bottom surface among the inner surfaces of the secondary battery can. The large surface 1100 module may be configured to include a first camera 310, a first coaxial lighting unit 320, a first mirror 330, and a first mirror adjustment unit 340.

The first camera 310 may directly capture the image of the bottom surface of the can. Also, the first camera 310 may be configured to capture images of the large surface 1100 reflected on a mirror.

The first coaxial lighting unit 320 may be configured to illuminate light to the inside of the can. The first coaxial lighting unit 320 may be provided vertically right above the can. The first coaxial unit may be configured to include a first lighting unit 321 provided at a position off the optical axis of the first camera 310 and a semi-reflective mirror not shown in the figure.

The first lighting unit 321 may consist of a plurality of units, each configured to emit light at different positions and capable of operating individually.

The first mirror 330 may be configured as a pair, each reflecting one of the large surfaces 1100 toward the first camera 310.

The first mirror adjustment unit 340 may be configured as a pair, each adjusting the position and/or angle of the first mirror 330. As the first mirror adjustment unit 340 operates, the angle at which the large surface 1100 of the can is viewed from the first camera 310 changes depending on the height.

The small surface imaging module 400 may be configured as a pair of second cameras 410, each of which captures images of the respective small surfaces 1200 as the distance between the small surfaces 1200 increases.

At this time, while it is possible to configure a single camera to capture images of both the small surface 1200 and the large surface 1100 simultaneously, using a pair of cameras is preferable to address issues such as limitations in the reflection angle by the mirror and interference with the first camera of the large surface inspection unit. Therefore, the small surface imaging module 400 is configured as a pair, and the second camera 410 is disposed vertically right above the second mirror 430 to increase the angle at which the small surface 1200 is viewed.

Specifically, the small surface imaging module 400 is configured to inspect a pair of small surfaces 1200. The small surface imaging module 400 may include a second camera 410, a second coaxial lighting unit 420, a second mirror 430, and a second mirror adjustment unit 440. The small surface imaging modules 400 are configured as a pair, each capturing images of a different small surface 1200.

Meanwhile, each second coaxial lighting unit 420 may be configured to include a plurality of second lighting units 421 similar to the first coaxial lighting unit 320. Also, the plurality of second lighting units may be configured to operate independently at different locations.

However, the configuration described above is only an example; the inspection device 1 according to the present disclosure may be modified and applied as a pair of large surface imaging modules 300 and a single small surface imaging module 400.

As described above, the large surface imaging module 300 and the small surface imaging module 400 according to the present disclosure may each include a mirror and a mirror adjustment unit. At this time, the size and shape of the first mirror 330 and the second mirror 430 may be the same or different. Also, the first mirror adjustment unit 340 and the second mirror adjustment unit 440 may be configured with similar settings and may be configured to adjust the angle and vertical and horizontal positions of the mirrors, respectively.

In what follows, for the convenience of description, the configuration of the first mirror 330 and the first mirror adjustment unit 340 set at a high position will be described.

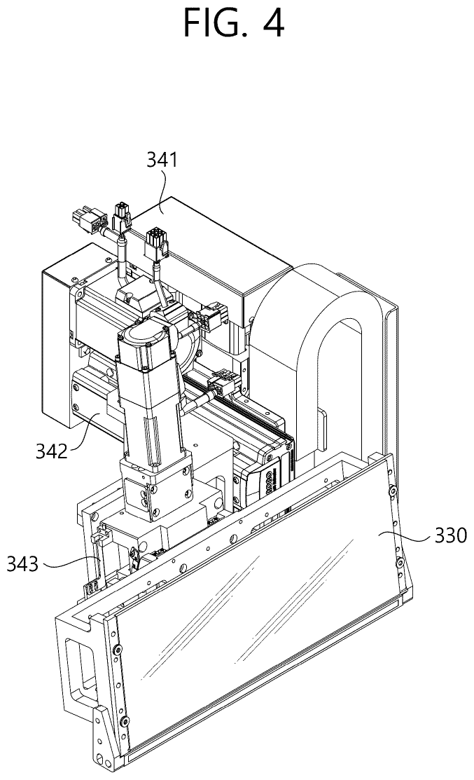

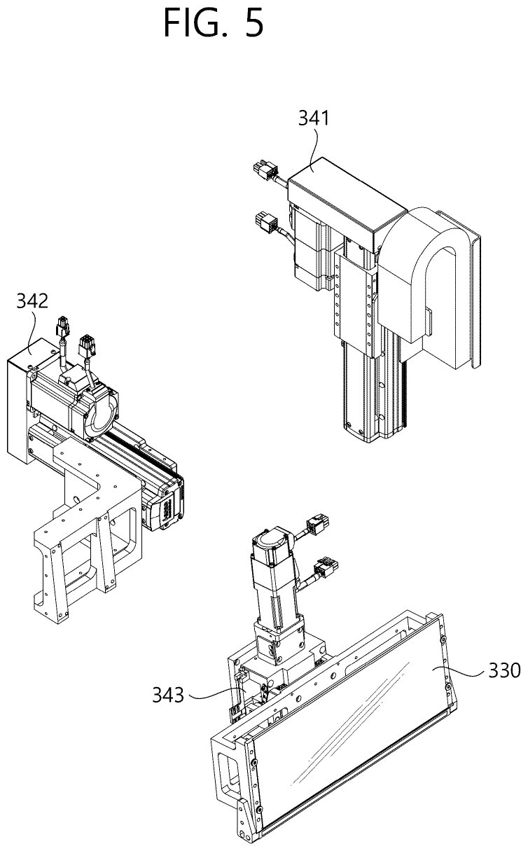

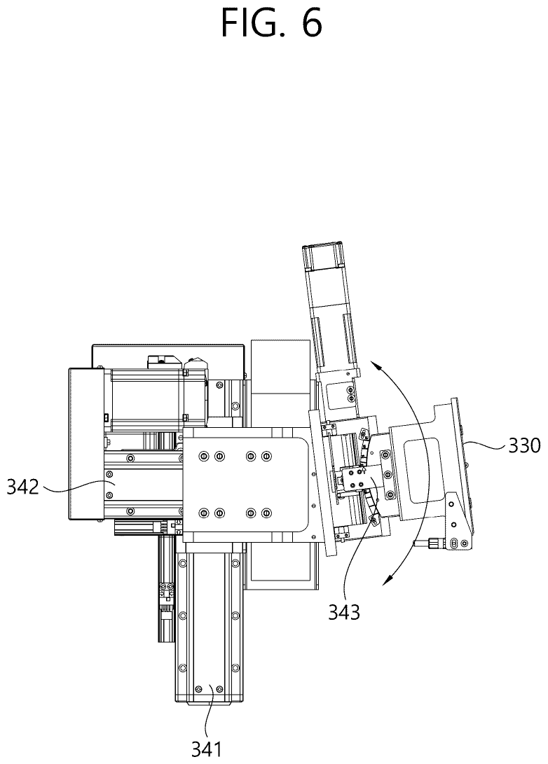

FIG. 4 is a perspective view of a first mirror and a first mirror adjustment unit, FIG. 5 is an exploded perspective view of the first mirror adjustment unit, and FIG. 6 shows an operation state illustrating the angle adjustment operation of the first mirror adjustment unit.

Referring to FIGS. 4 and 5, the first mirror adjustment unit 340 may be configured to include a first horizontal driving unit 342, a first vertical driving unit 341, and a first rotation driving unit 343. One side of the first vertical driving unit 341 may be secured to the fixed frame 200. The other side of the first vertical driving unit 341 may be equipped with the first horizontal driving unit 342. The first rotation driving unit 343 may be provided at the end of the first horizontal driving unit 342. The first rotation driving unit 343 may be configured to include a link mechanism, allowing a linear motion to ultimately adjust the angle of the mirror. However, the description above is only an example and may be modified and provided in various configurations capable of adjusting the angle.

Meanwhile, although not shown in the figure, similarly to the configuration of the first mirror adjustment unit 340, the second mirror adjustment unit 440 may also be configured to include a second vertical driving unit 441, a second horizontal driving unit 442, and a second rotation driving unit 443.

Referring to FIG. 6, the concept of changing the center of the mirror and adjusting the angle of the mirror through the operation of the first mirror adjustment unit 340 is shown. The first mirror adjustment unit 340 may be operated in conjunction with the first camera 310. The first mirror adjustment unit 340 may adjust the position and/or angle of the first mirror 330 when the first camera 310 captures images of the upper area, the middle area, and the lower area of the large surface 1100. Meanwhile, if the size or shape of the can changes, the amount of position change and/or angle adjustment may vary accordingly.

Meanwhile, although not shown in the figure, the second mirror adjustment unit 440 may also operate similarly to the first mirror adjustment unit 340.

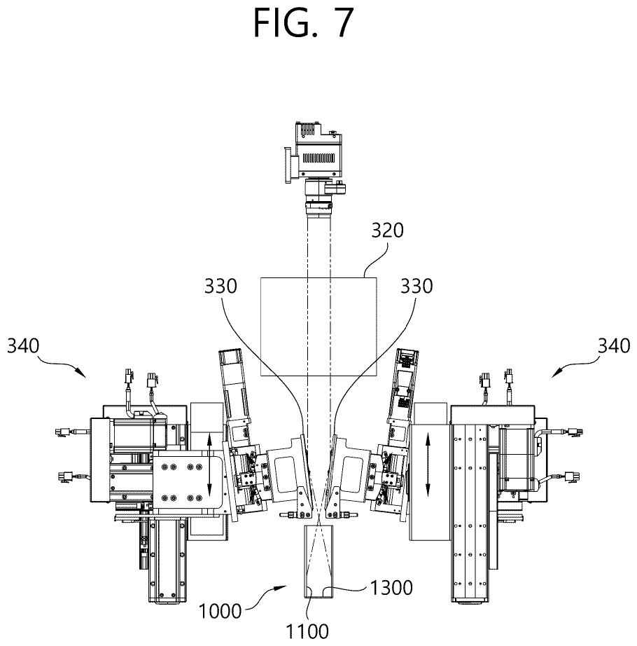

FIG. 7 illustrates the operation of a large surface imaging module according to one embodiment of the present disclosure.

Referring to FIG. 7, when the first coaxial lighting unit 320 is operated, the first camera 310 may capture the image of the bottom surface of the can provided directly below and a pair of large surfaces 1100 reflected on a pair of first mirrors 330. At this time, images are captured by adjusting the camera to a longer focal length than that used for imaging the bottom surface 1300.

Also, the first mirror adjustment unit 340 may adjust the angle of the first mirror 330 so that images of the low and high areas of the large surface 1100 are captured respectively. Also, the position of the first mirror 330 may be adjusted. Although not shown in the figure, the controller may perform control by analyzing the images acquired from the image processor. The image processor may analyze the images and determine whether the angle and posture of the first mirror 330 need to be adjusted. Also, the image processor may determine whether the focal length adjustment is necessary. The controller may operate the first mirror adjustment unit 340 or adjust the focal length of the first camera 310 module based on the value received from the image processor.

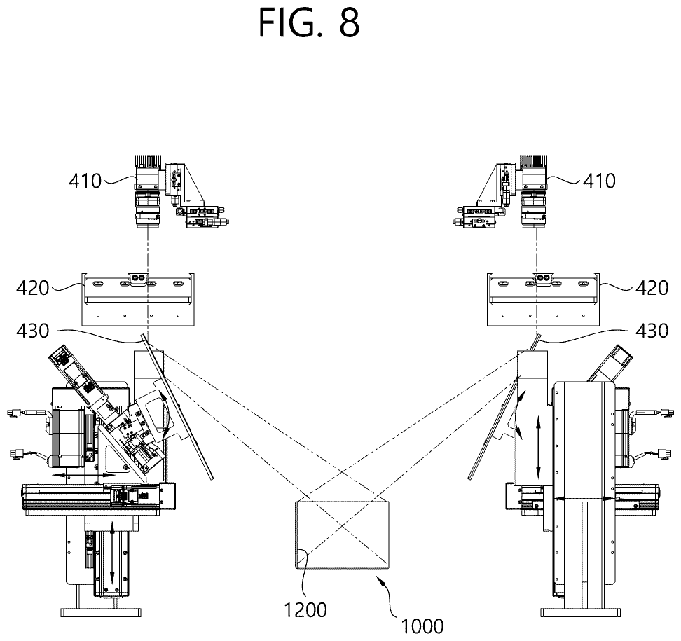

FIG. 8 illustrates the operation of a small surface imaging module according to one embodiment of the present disclosure.

Referring to FIG. 8, each small surface imaging module 400 captures images of the small surfaces 1200. At this time, the second coaxial lighting unit 420 may be controlled to illuminate light while in operation, and the posture of the second mirror 430 may be adjusted so that images of the high area of the small surface 1200 and the low area of the small surface 1200 are captured. Meanwhile, the image processor may adjust the position and posture of the second mirror 430 based on the captured. Also, the focus of the second camera 410 may be adjusted based on the image captured by the image processor.

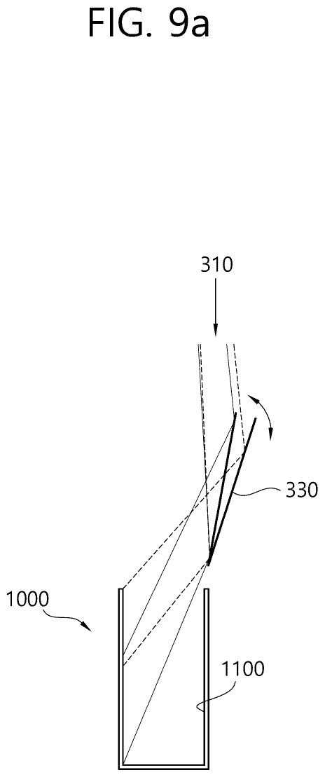

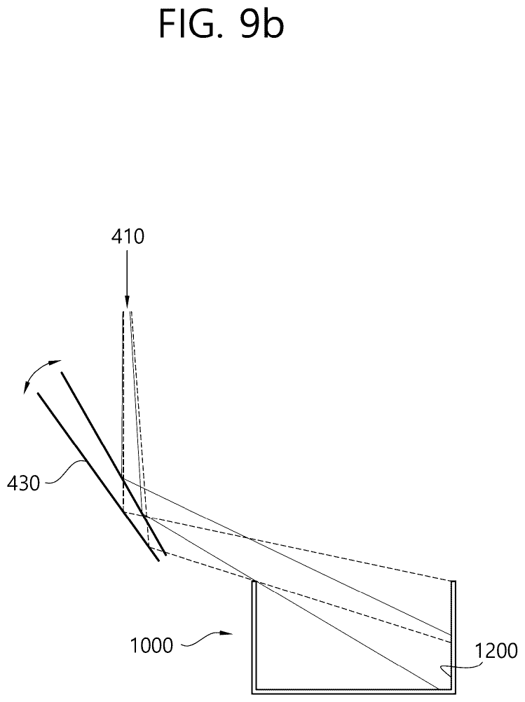

FIG. 9a illustrates the imaging area according to the operation of the large surface imaging module according to one embodiment of the present disclosure.

Referring to FIG. 9a, the large surface imaging module 300 may change the angle of the first mirror 330 to incline upward when capturing images of a higher area. In other words, in this case, the first mirror adjustment unit 340 may be operated to have a moderate slope. At this time, the maximum angle of the first mirror 330 may vary depending on the shape of the can and the positions of the first camera 310 and the first mirror 330.

The angular position of the first mirror adjustment unit 340 may be adjusted to increase the inclination of the first mirror 330 when capturing images of a lower area. Also, the first mirror adjustment unit 340 may adjust the vertical and/or horizontal position of the first mirror 330 when images of the upper and lower parts of the large surface 1100 are captured.

Meanwhile, although not shown in the figure, the angular position of the first mirror adjustment unit 340 may be adjusted multiple times when capturing images of the large surface 1100, and the focus of the first camera 310 may be adjusted accordingly each time to capture the images.

For example, the large surface imaging module 300 may capture images of areas with different heights by adjusting a pair of first mirror adjustment units 340 three times. For example, the first camera 310 may capture images of the upper area of a pair of large faces 1100, the middle area of a pair of large faces 1100, and the lower area of a pair of large faces 1100.

FIG. 9b illustrates the imaging area according to the operation of the small surface imaging module according to one embodiment of the present disclosure.

Referring to FIG. 9b, according to one embodiment of the present disclosure, a pair of small surface imaging modules 400 may symmetrically adjust the second mirror adjustment unit 440 and capture images of the small surface 1200. A pair of second cameras 410 are configured to capture images of the respective small surfaces 1200 directly facing them. At this time, when capturing images of the upper area and the lower area of the small surface 1200, the angle and position of the second mirror 430 may be adjusted.

Meanwhile, the second camera 410 may capture multiple images while the angle and/or position of the second mirror 430 is fixed. At this time, each image may be captured whenever the light-emission combination of the second lighting unit 421 is changed. The detection accuracy through image analysis may be improved by combining multiple images captured at one angular position of the mirror.

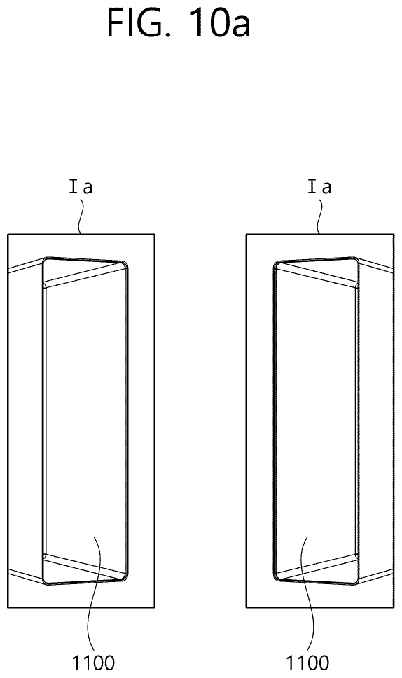

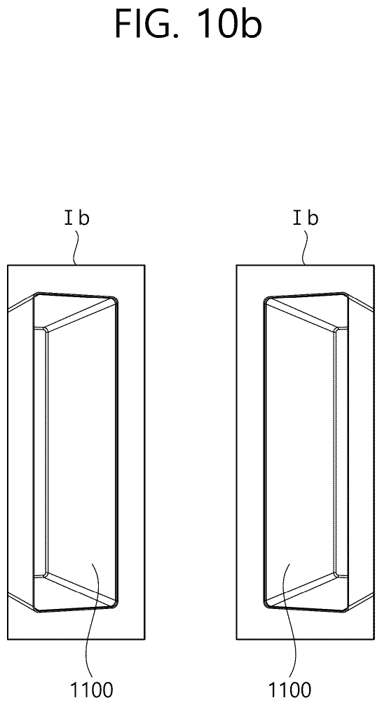

FIGS. 10a and 10b are images obtained by the operation of the large surface imaging module according to one embodiment of the present disclosure. For the convenience of description, only the area reflected in the mirror is shown.

Referring to FIG. 10a, the large surface imaging module 300 according to one embodiment of the present disclosure may adjust the position and/or angle of a pair of first mirrors 330 to capture an upper area of the large surface 1100. Therefore, the first camera 310 obtains an image Iₐ which appears as if captured at a large angle nearly perpendicular to the large surface 1100.

Referring to FIG. 10b, according to one embodiment of the present disclosure, the large surface imaging module 300 may greatly adjust the angle of a pair of first mirrors 330 to capture images of the lower area of the large surface 1100. Also, the position of the first mirror 330 may be adjusted. Therefore, the first camera 310 obtains an image I_{b} of the reflected side surface, revealing the deeper interior of the can.

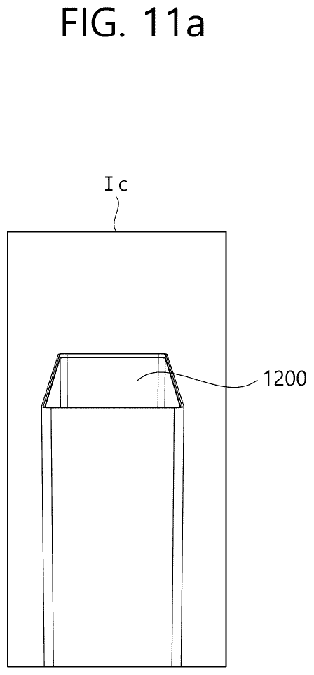

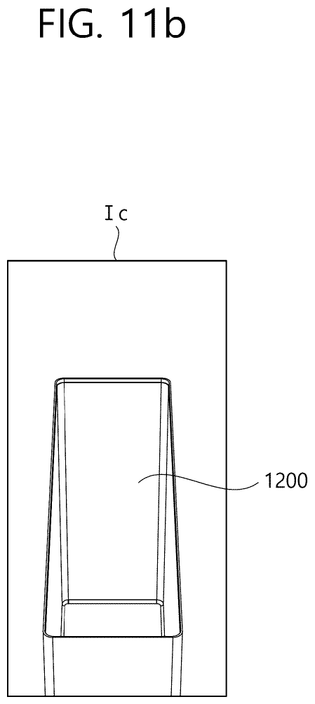

FIGS. 11a and 11b are images obtained by the operation of the small surface imaging module according to one embodiment of the present disclosure.

Referring to FIG. 11a, the small surface imaging module 400 according to the present disclosure obtains an image I_{c} which appears as if captured from a higher angle relative to the surface of the upper area by one of small surface imaging modules 400.

Referring to FIG. 11b, the second mirror adjustment unit 440 may be adjusted to capture an image I_{d} which appears as if viewed from a lower angle relative to the small surface 1200 by the second camera 410. In other words, the small surface imaging module 400 obtains images from varying angles at each height of the small surface 1200.

Meanwhile, the image acquisition described with reference to FIGS. 11a and 11b may be performed simultaneously for a pair of small surfaces 1200 by a pair of second cameras 410, a second mirror 430, and a second mirror adjustment unit 440.

As described above, the internal inspection device 1 for a prismatic can of a secondary battery according to the present disclosure may obtain images which appear as if captured from varying angular positions while the can for the secondary battery is left untouched.

Therefore, the time required for the internal inspection for a prismatic can of a secondary battery 1000 may be greatly reduced, and the inspection accuracy may also be greatly improved.

[Detailed description of main elements]

| | |
|---|---|
| 1. Internal inspection device for a | |
| prismatic can of a secondary battery | |
| 10. Base | |
| 100: Mounting unit | 200: Fixed frame |
| 300: Large surface imaging module | 310: First camera |
| 320: First coaxial lighting unit | 321: First lighting unit |
| 330: First mirror | 340: First mirror adjustment unit |
| 341: First vertical driving unit | 342: First horizontal driving unit |
| 343: First rotation driving unit | |
| 400: Small surface imaging module | 410: Second camera |
| 420: Second coaxial lighting unit | 421: Second lighting unit |
| 430: Second mirror | 440: Second mirror adjustment unit |
| 441: Second vertical driving unit | 442: Second horizontal driving unit |
| 443: Second rotation driving unit | 1000: Prismatic can for secondary |
| | battery |
| 1100: Large surface | 1200: Small surface |

1. An internal inspection device for a prismatic can of a secondary battery, the device comprising:
a mounting unit configured to mount a prismatic can for a secondary battery;
a large surface imaging module configured to capture images of an inner large surface of the prismatic can mounted on the mounting unit; and
a small surface imaging module configured to capture images of an inner small surface of the prismatic can mounted on the mounting unit,
wherein the large surface imaging module comprises a first camera, a first coaxial lighting unit, a first mirror, and a first mirror adjustment unit;
the small surface imaging module comprises a second camera, a second coaxial lighting unit, a second mirror, and a second mirror adjustment unit;
the first mirror adjustment unit is configured to adjust the position and/or angle of the first mirror; and
the second mirror adjustment unit is configured to adjust the position and/or angle of the second mirror.

2. The device of claim 1, wherein the first mirror and the first mirror adjustment unit are provided in pairs to capture images of a pair of the large surfaces.

3. The device of claim 2, wherein the small surface imaging module is configured to capture images of the small surface viewed from different angles according to the height of the small surface.

4. The device of claim 3, wherein the small surface imaging module is configured as a pair.

5. The device of claim 4, wherein the pair of first mirrors are provided on the outer sides of the pair of large surfaces, each configured to incline at a predetermined angle in the upward direction.

6. The device of claim 5, further including a fixed frame configured to hold the large surface imaging module and the small surface imaging module above a predetermined height,
wherein the mounting unit is configured to move inwardly within the fixed frame.

7. The device of claim 6, wherein the first camera is configured to adjust the focus in response to the angle and/or position adjustment of the first mirror.

8. The device of claim 6, wherein the second camera is configured to adjust the focus in response to the angle and/or position adjustment of the second mirror.

9. The device of claim 6, wherein the first coaxial lighting unit is configured to include a plurality of first lighting units, and the plurality of first lighting units are configured to be individually controlled.

10. The device of claim 6, wherein the second coaxial lighting unit is configured to include a plurality of second lighting units, and the plurality of second lighting units are configured to be individually controlled.
